(19) United States
(12) Patent Application Publication
(10) Pub. No.: US 2007/0163834 A1
(43) Pub. Date: Jul. 19, 2007

(54) Slidable beam anchor

(75) Inventor: Scott C. Casebolt, St. Paul Park, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/612,581

(22) Filed: Dec. 19, 2006

Related U.S. Application Data
(60) Provisional application No. 60/755,904, filed on Jan. 3, 2006.

(51) Int. Cl. A62B 35/00

(52) U.S. Cl. 182/3

(57) ABSTRACT

A slidable beam anchor (100) has an elongate member (101) including a plurality of notches (105) along which at least one engaging member (130) is adjustable along the length of the elongate member (101) with an adjustment member (155) protected within a cavity (137) of the engaging member (130) below the elongate member (101) to prevent accidental release of the adjustment member (155) from the notch (105) of the elongate member (101).

This application claims the benefit of U.S. Provisional Application No. 60/755,904, filed Jan. 3, 2006.

### FIELD OF THE INVENTION

The present invention relates to a slidable beam anchor.

### BACKGROUND OF THE INVENTION

Various occupations place workers in precarious positions at relatively dangerous heights thereby creating a need for fall protection safety apparatus. Among other things, such apparatus usually include a safety line interconnected between a support structure and a person working in proximity to the support structure.

During construction of steel frame structures, for example, a slidable beam anchor is commonly secured to a flanged structural beam such as an I-beam and a lanyard interconnects the slidable beam anchor and a safety harness donned by a worker to protect the worker from a fall.

Slidable beam anchors should not hinder the workers' ability to perform tasks. Therefore, slidable beam anchors should be easily slidable along the length of the beam without getting caught or wedged on the beam. Further, slidable beam anchors should also be lightweight and easy to secure and disconnect from the beam. Even further, slidable beam anchors should not be easily inadvertently disengaged.

The present invention addresses the problems associated with the prior art devices and provides for a slidable beam anchor that is lightweight, is easily slidable along the length of a beam, is easily securable and disconnectable from the beam, and is not easily inadvertently disengaged.

### SUMMARY OF THE INVENTION

One aspect of the present invention provides for a slidable beam anchor for anchoring a lanyard to a beam including an elongate member and at least one engaging member. The elongate member has a length, a first end, a second end, and a plurality of notches extending along at least a portion of the length proximate at least one of the ends. The at least one engaging member includes a housing defining a cavity in which an adjustment member is pivotally connected to the housing. The adjustment member has a locking portion and an activating portion and is pivotable between an engaged position and a released position. The locking portion engages one of the plurality of notches in the engaged position, and the locking portion is disengaged from the plurality of notches in the released position. The adjustment member is protected within the cavity when in the engaged position thereby preventing accidental release of the adjustment member from the one of the plurality of notches.

Another aspect of the present invention provides for a slidable beam anchor for anchoring a lanyard to a beam including an elongate member, a first engaging member, and a second engaging member. The elongate member has a length, a first end, a second end, and a plurality of notches extending along at least a portion of the length proximate at least one of the ends. The first engaging member is slidably operatively connected to the first end. The first engaging member has a housing, a cavity, and an adjustment member. The cavity is positioned within the housing and the adjustment member is positioned within the cavity and pivotally operatively connected to the housing. The adjustment member has a locking portion and an activating portion and is pivotable between an engaged position and a released position. The engaged position is when the locking portion engages one of the plurality of notches, and the released position is when the adjustment member is moved so that the locking portion is disengaged from the one of the plurality of notches. The adjustment member is protected within the cavity in the engaged position to prevent accidental release of the adjustment member from the one of the plurality of notches. The first engaging member is adjustable along the length of the elongate member. The second engaging member is operatively connected to the second end, wherein the beam is engaged by the first engaging member and the second engaging member to slidably operatively connect the beam anchor thereto.

Another aspect of the present invention provides for a slidable beam anchor for anchoring a lanyard to a beam including an elongate member and at least one engaging member. The elongate member includes a length, a first end, a second end, and a plurality of notches extending along at least a portion of a bottom surface proximate at least one of the ends. The at least one engaging member is slidably operatively connected to one of the ends and includes a housing and an adjustment member. The housing includes a top portion and a bottom portion. The top portion is configured and arranged to slidably engage the elongate member, and the bottom portion includes a first side and a second side extending downward from the top portion proximate a bottom surface of the elongate member. The first side and the second side define a cavity therebetween. The adjustment member is pivotally operatively connected within the cavity between the first side and the second side. The adjustment member has a locking portion and an activating portion and is pivotable between an engaged position and a released position. The adjustment member is biased in the engaged position. The locking portion extends upward and is configured and arranged to engage one of the plurality of notches within the housing when the adjustment member is in the engaged position. The activating portion extends downward and is configured and arranged to be moved inward relative to the one of the ends thus causing the locking portion to move downward to disengage one of the plurality of notches to be in the released position. The locking portion and the activating portion are within the cavity of the housing in the engaged position thereby protecting the adjustment member within the housing in the engaged position. The housing and the elongate member protect the adjustment member from accidental release from one of the plurality of notches by the lanyard during use of the slidable beam anchor.

### BRIEF DESCRIPTION OF THE DRAWINGS

FIG. 1 is a front perspective view of a slidable beam anchor constructed according to the principles of the present invention;

FIG. 2 is a front view of the slidable beam anchor shown in FIG. 1;

FIG. 3 is a top view of the slidable beam anchor shown in FIG. 1;

FIG. 4 is a side view of the slidable beam anchor shown in FIG. 1;

FIG. 5 is a cross-section view of an end of the slidable beam anchor taken along lines 5-5 in FIG. 3;

FIG. 6 is a top view of an elongate member of the slidable beam anchor shown in FIG. 1 with hidden lines showing a plurality of notches on the bottom surface of the elongate member;

FIG. 7 is a side view of the elongate member shown in FIG. 6;

FIG. 8 is a front view of the elongate member shown in FIG. 6;

FIG. 9 is a side view of an engaging member of the slidable beam anchor shown in FIG. 1;

FIG. 10 is a front view of the engaging member shown in FIG. 9;

FIG. 11 is a front view of a plate member of the slidable beam anchor shown in FIG. 1;

FIG. 12 is a side view of the plate member shown in FIG. 11;

FIG. 13 is a front view of an adjustment member of the slidable beam anchor shown in FIG. 1;

FIG. 14 is a bottom view of the adjustment member shown in FIG. 13;

FIG. 15 is a side view of the adjustment member shown in FIG. 13;

FIG. 16 is a side view of a spring of the slidable beam anchor shown in FIG. 1;

FIG. 17 is a front view of the spring shown in FIG. 16;

FIG. 18 is a side view of an interconnecting member of the slidable beam anchor shown in FIG. 1;

FIG. 19 is a front view of the interconnecting member shown in FIG. 18;

FIG. 20 is a front view of a connector of the slidable beam anchor shown in FIG. 1;

FIG. 21 is a side view of the connector shown in FIG. 20;

FIG. 22 is a side perspective view of a slidable beam anchor constructed according to the principles of the present invention in an engaged position; and

FIG. 23 is a side perspective view of the slidable bean anchor shown in FIG. 22 in a released position.

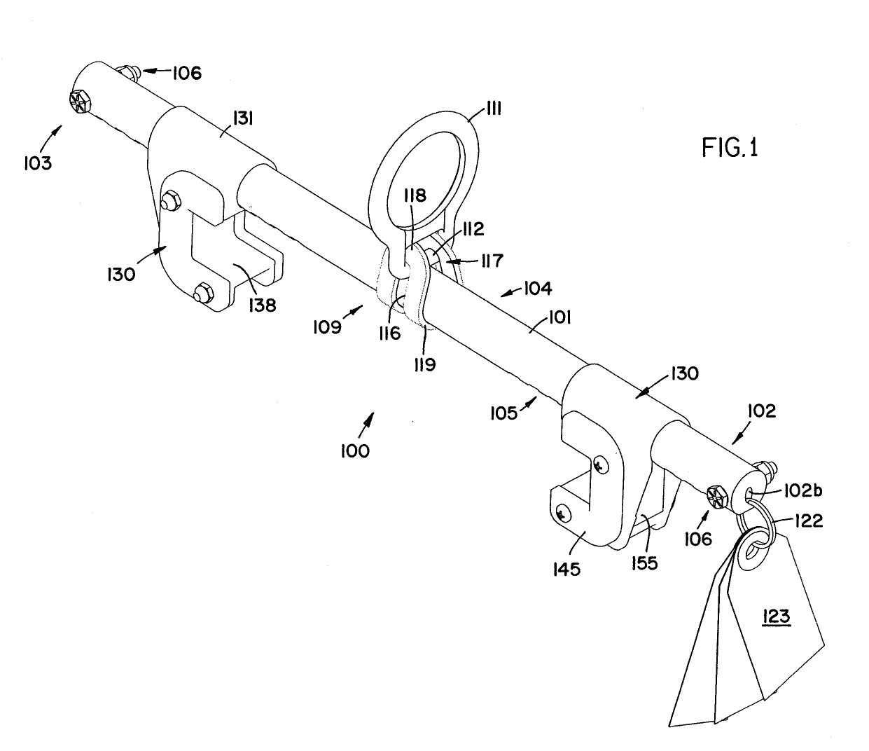

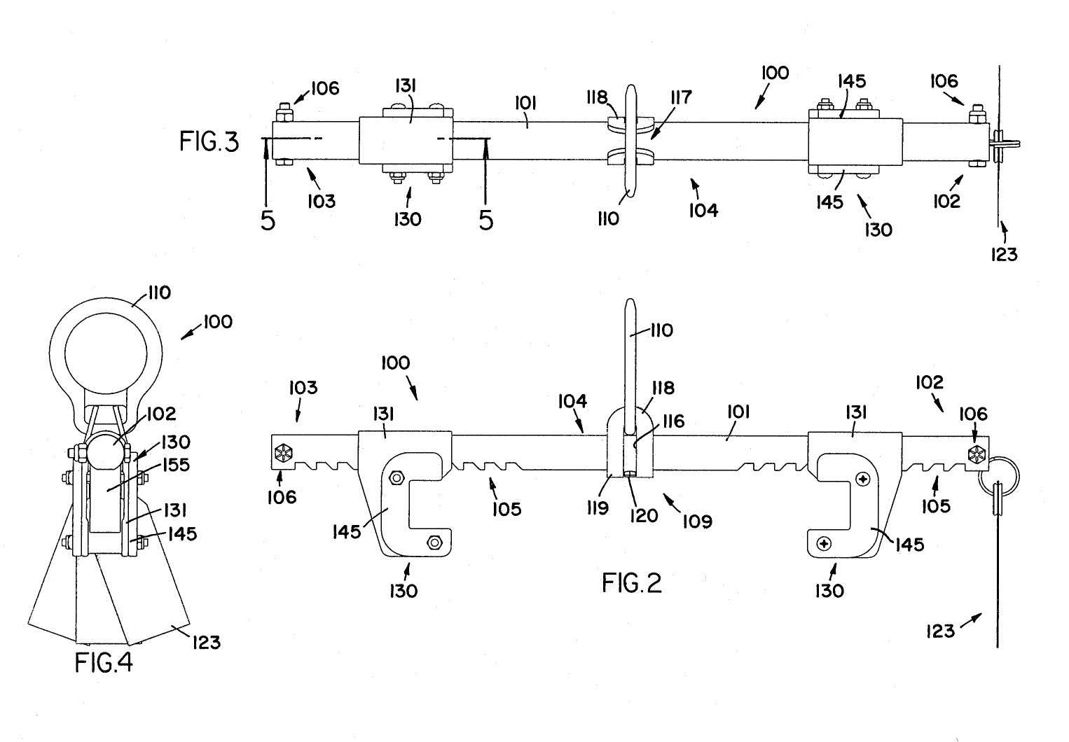

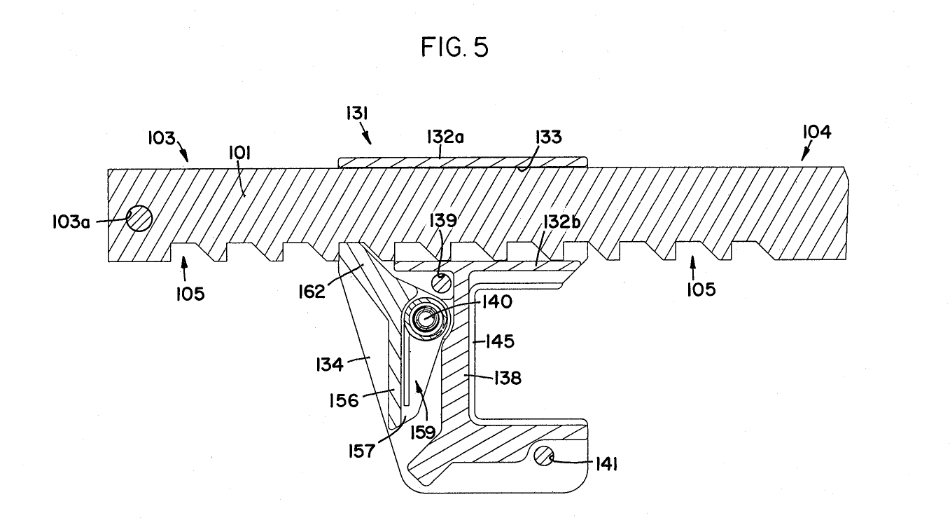

### DETAILED DESCRIPTION OF A PREFERRED EMBODIMENT

A slidable beam anchor constructed according to the principles of the present invention is designated by the numeral 100 in the drawings.

The slidable beam anchor 100 is configured and arranged to slidably engage a beam such as an I-beam with a top flange and a bottom flange, and the slidable beam anchor 100 may be attached to either the top flange or the bottom flange of the beam to provide an anchorage point for a worker performing tasks proximate the beam. It is recognized that the I-beam could be placed in various orientations also suitable for use with the slidable beam anchor 100. For example, the I-beam could also be oriented so that the flanges extend along the sides of the beam rather than along the top and the bottom of the beam in which case the slidable beam anchor 100 may be attached to either side of the beam, Further, the slidable beam anchor 100 could also be used with a T-shaped beam with a single flange in various orientations also suitable for use with the slidable beam anchor 100. The slidable beam anchor 100 is described in the orientation in which it would be when connected to the top flange of a beam, but it is recognized that the slidable beam anchor 100 could be oriented so that it could also be connected to the flange of a beam in various orientations. Therefore, the orientations may be adjusted accordingly. The slidable beam anchor 100 includes an elongate member 101, a connector assembly 109, and at least one engaging member 130.

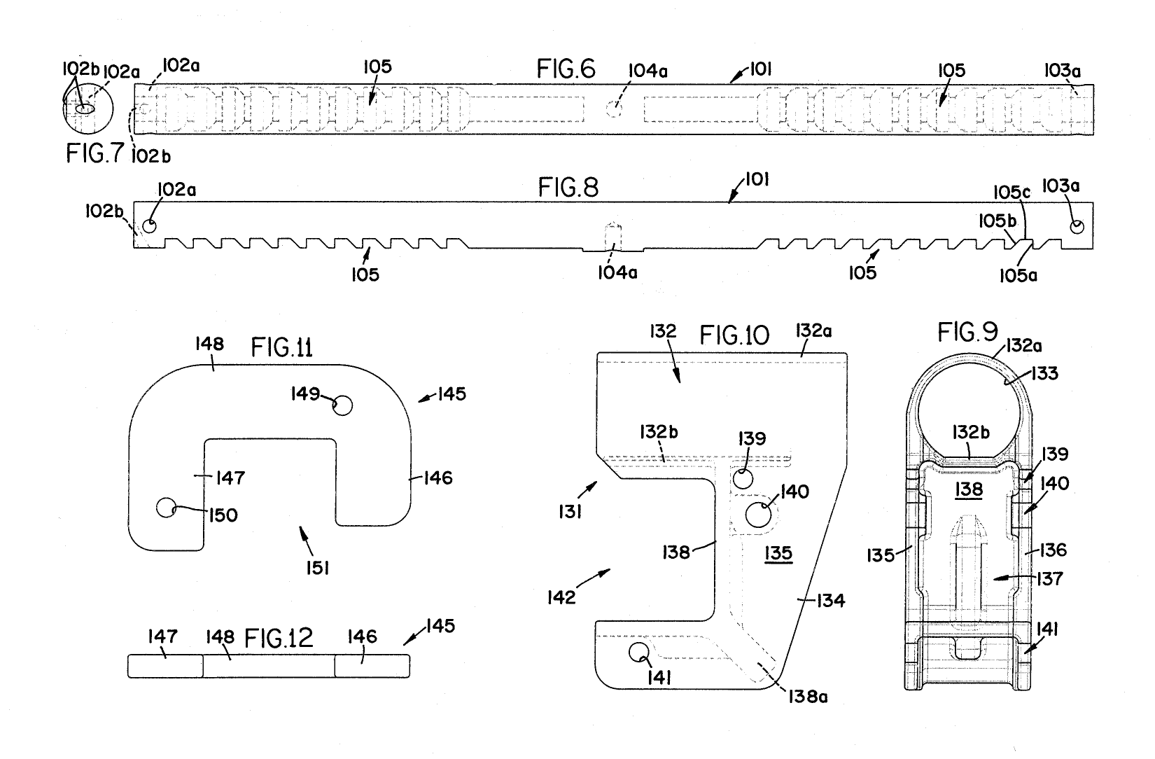

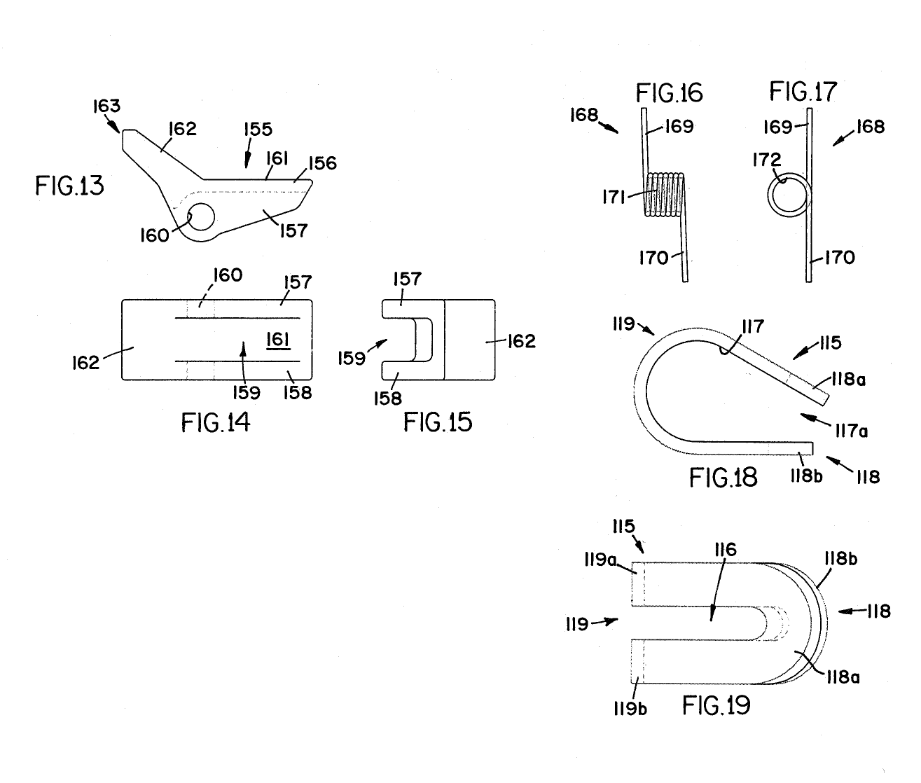

The elongate member 101 is preferably a rod having a generally circular cross-section including a first end 102, a second end 103, and an intermediate portion 104 between the first end 102 and the second end 103. The first end 102 includes a bore 102a extending laterally therethrough proximate the terminal end and a bore 102b extending diagonally from a middle portion of the terminal end downward to the bottom of the first end 102 proximate below the bore 102a. The second end 103 includes a bore 103a extending laterally therethrough proximate the terminal end, The bores 102a, 102b, and 103a are shown in FIGS. 6-8. A fastener 106 extends through bores 102a and 103a and each fastener 106 is secured to the respective ends 102 and 103. Labels 123 may be connected to the elongate member 101 with a ring 122 through the bore 102b. The intermediate portion 104 includes an opening 104a proximate a middle portion of the intermediate portion 104 extending from the bottom to proximate a middle of the elongate member 101. On the bottom surface along the longitudinal axis of the elongate member 101 are a plurality of notches 105. The plurality of notches 105 are preferably located between the bore 102a and the opening 104a and between the bore 103a and the opening 104a, but it is recognized that the plurality of notches 105 may be proximate one end or the other rather than proximate both ends of the elongate member 101 if only one engaging member 130 is used. The plurality of notches 105 are laterally extending from one side to the other side, preferably having a perpendicular surface 105a on the side of the notch 105 closer to the respective end 102 or 103, a slanting surface 105b on the side of the notch 105 further from the respective end 102 or 103, and a top surface 105c along the top of the notch 105 interconnecting the perpendicular surface 105a and the slanting surface 105b as shown in FIG. 8.

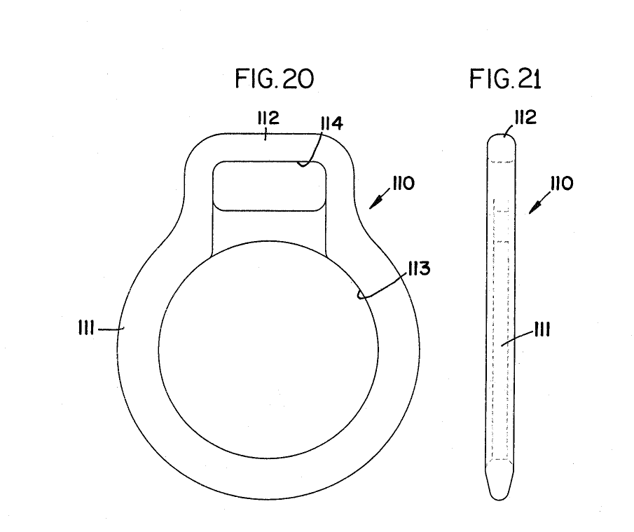

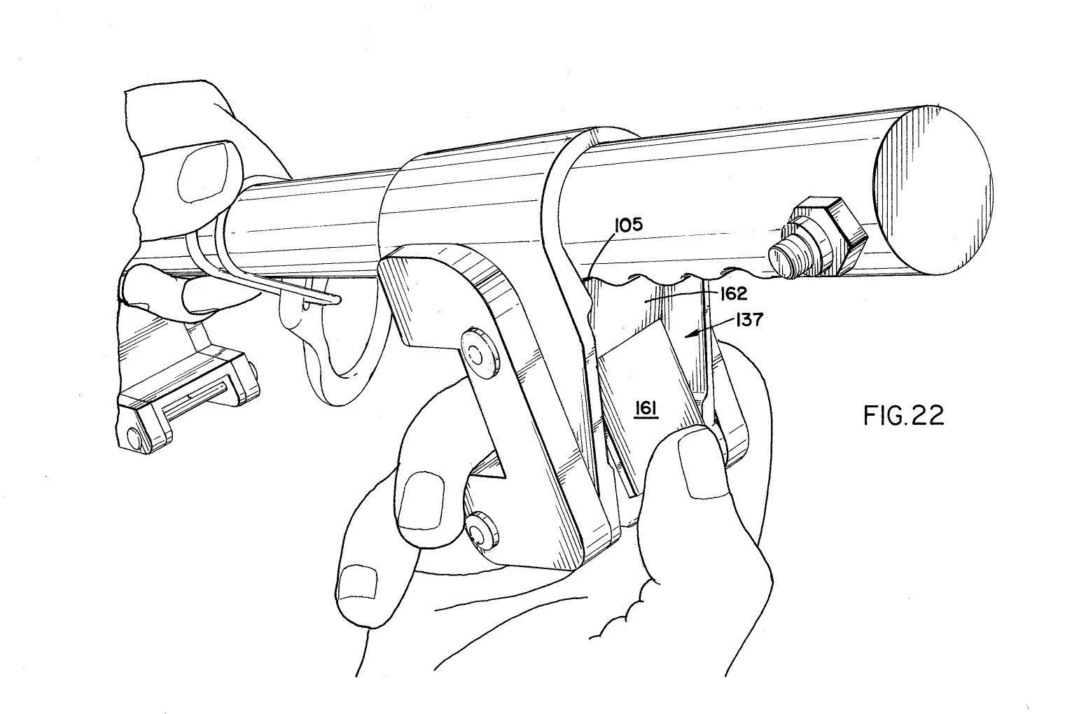

The connector assembly 109 includes a connector 110 and an interconnecting member 115. The connector 110 is preferably a D-ring including a ring portion 111 having an opening 113 and a connecting portion 112 having a slot 114 as shown in FIGS. 20 and 21. The interconnecting member 115 is preferably U-shaped from both a side view and a front view as shown in FIGS. 18 and 19. The interconnecting member 115 includes a bottom 119 and a top 118 having a first end 118a and a second end 118b, which are interconnected by the bottom 119 to form a U-shape as shown in the side view in FIG. 18. Between the first end 118a and the second end 118b is an opening 117a into a cavity 117 defined by the bottom 119 and the ends 118a and 118b. The interconnecting member 115 also includes a slot 116 extending from the bottom 119 into the top 118 to form another U-shape and dividing the bottom 119 into a first portion 119a and a second portion 119b as shown in the front view in FIG. 19. Either of the portions 119a or 119b is inserted through the slot 114 of the connector 110 so that the connector 110 is proximate the top 118 of the interconnecting member 115. A fastener 120 is inserted within the slot 116 proximate the bottom 119 and into the opening 104a to connect the interconnecting member 115 to the elongate member 101, thus connecting the connector 110 to the elongate member 101.

The slidable beam anchor 100 includes at least one engaging member 130. Preferably two engaging member's 130 are used, only one of which must be slidable along the length of the elongate member 101 proximate the plurality of notches 105. Alternatively, one engaging member 130 is used with another engaging member that is secured to the elongate member 101. The engaging member 130 includes a slidable member 131, plate members 145, and an adjustment member 155.

As shown in FIGS. 9 and 10, the slidable member 131 is preferably a U-shaped member including a top portion 132 and a bottom portion 134. The top portion 132 is preferably cylindrical and sleeve-like having a bore 133 through which the elongate member 101 extends and is slidable therethrough. A top 132a and a bottom 132b define the bore 133, the top 132a being positioned above the elongate member 101 and the bottom 132b being positioned below the elongate member 101. The bottom 132b does not extend all the way to the side of the slidable member 131 closer to the respective end 102 or 103 of the elongate member 101. The bottom portion 134 extends downward below the elongate member 101 from the top portion 132 proximate the middle of the top portion 132 and the side closer to the respective end 102 or 103.

The bottom portion 134 includes a first side 135, a second side 136, and an interconnecting side 138. The first side 135 and the second side 136 extend downward parallel to one another from proximate the front and the rear of the elongate member 101, and the interconnecting side 138 interconnects the first side 135 and the second side 136 proximate the side of the slidable member 131 further from the respective end 102 or 103. The first and second sides 135 and 136 are preferably L-shaped with the top portion of the “L” tapered downward toward the bottom portion of the “L” and the bottom portion of the “L” extending away from the respective end 102 or 103. Thus, the top of the top portion is wider than the bottom of the top portion of the “L”. The top portion 132 extends parallel to the bottom portion of the “L”, thus defining a U-shaped member having an opening 142 configured and arranged to engage the flange of the beam between the slidable members 131 proximate each end 102 and 103. The interconnecting side 138 includes a protrusion 138a extending between the sides 135 and 136 from the bottom corner of the “L” at a downward angle toward the bottom side closer to the respective end 102 or 103. A cavity 137 is defined between the first and second sides 135 and 136, the interconnecting side 138, and the protrusion 138a.

The first and second sides 135 and 136 include corresponding apertures 139, 140, and 141. The aperture 139 extends through the bottom portion 134 proximate the bottom 132b of the top portion 132 and the interconnecting side 138. The aperture 140 extends through the bottom portion 134 proximate below the aperture 139. The aperture 141 extends through the bottom portion 134 proximate the end of the bottom portion of the Plate members 145 are generally U-shaped plates corresponding with the portion of the slidable member 131 defining the opening 142. A plate member 145 is operatively connected to the front and to the rear of each slidable member 131. A middle portion 148 interconnects a top portion 146 and a bottom portion 147 to form the U-shape defining an opening 151. The top portion 146 is positioned proximate the bottom 132b of the top portion 132, the bottom portion 147 is positioned proximate the bottom portion of the “L” of the bottom portion 134, and the middle portion 148 is positioned proximate the top portion of the “L” of the bottom portion 134. The opening 151 corresponds with the opening 142. The plate members 145 include apertures 149 corresponding with aperture 139 and apertures 150 corresponding with aperture 141 through which fasteners may be inserted to operatively connect the plate members 145 to the slidable members 131.

An adjustment member 155, which is preferably a ratchet pawl, includes an activating portion 156 and a locking portion 162. The activating portion 156 includes a contact portion interconnecting a first side 157 and a second side 158, which extend outward from the contact portion to define a cavity 159 therebetween. Proximate the juncture of the activating portion and the locking portion 162 is an aperture 160 extending through the first and second sides 157 and 158. The locking portion 162 extends outward from the activating portion 156 at an angle and includes an end 163 corresponding to the surfaces 105a, 105b, and 105c of the plurality of notches 105.

A spring 168 includes a first end 169 and a second end 170 interconnected by a coiled portion 171 defining an aperture 172 as shown in FIGS. 16 and 17. The spring 168 fits within the cavity 159 of the adjustment member 155 so that the aperture 172 corresponds with the aperture 160 and the first end 169 extends between the aperture 160 and the locking portion 162 and the second end 170 extends along the contact portion 161. The aperture 160 of the adjustment member 155 and the aperture 172 of the spring 168 correspond with the aperture 140 of the slidable member 131, and a fastener is inserted through these apertures 140, 160, and 172 to operatively connect them together. The spring 168 biases the adjustment member 155 so that the locking portion 162 is biased upward to engage one of the plurality of notches 105. The activating portion 156 must be moved inward to overcome the force of the spring 168 to pivot the adjustment member 155 about the fastener thus moving the locking portion 162 downward to disengage the locking portion 162 from the notch 105.

When the slidable member 131 is pushed inward toward the connector assembly, the adjustment member 155 may pivot to release the locking portion 162 from the notch 105 because the end 163 may slide over the slanting surface 105b, but the slidable member 131 may not be pushed outward toward the respective end 102 or 103 without first manually pushing the activating portion 156 inward to move the locking portion 162 away from the notch 105 because the end 163 may not slide over the perpendicular surface 105a. The locking portion 162 and the plurality of notches 105 are configured and arranged so that the end 163 may slide over the slanting surface 105b by simply pushing the slidable member 131 toward the connector assembly 109 but cannot slide over the perpendicular surface 105a by pushing the slidable member 131 toward the respective end 102 or 103.

The adjustment member 155 is entirely protected within the cavity 137 when the locking portion 162 engages the notch 105, Because the bottom 132b does not extend all the way to the side of the slidable member 131, the adjustment member 155 can engage the notches 105 within the cavity 137. The sides 135 and 136 and the interconnecting side 138 protect the adjustment member 155 within the cavity 137, including the locking portion 162 when the notch 105 is engaged. The protection of the entire adjustment member 155 in the engaged position ensures that the adjustment member 155 will not be accidentally released from the notch 105. If the locking portion 162 were exposed, the locking portion 162 could catch on an object such as a lanyard, a lifeline, a worker's shoe, or any number of other objects to cause the locking portion 162 to move and release the notch 105 thus allowing the slidable member 131 to be slid toward the respective end 102 or 103 and release the flange of the beam thus releasing the anchorage point of the fall protection system. Because the adjustment member 155, including the locking portion 162, is protected by the sides 135 and 136 and the interconnecting side 138 in the engaged position, the worker must access the activating portion 156 within the cavity 137 to release the adjustment member 155 from the notch 105. Further, because the adjustment member 155 is positioned below the elongate member 101, the elongate member 101 also protects the adjustment member 155 from accidental release because it is not as accessible to the above-mentioned objects. Therefore, the adjustment member 155 must be accessed below the elongate member 101 and within the cavity 137.

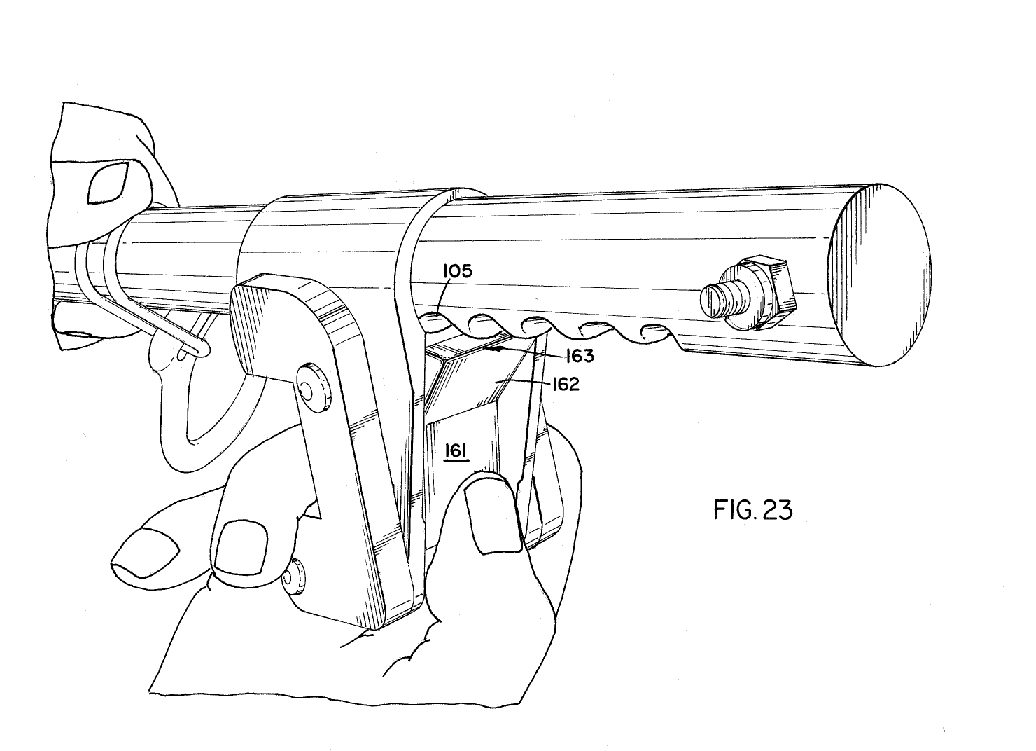

In operation, the slidable beam anchor 100 is placed proximate the flange of a beam. The engaging members 130 are positioned proximate the terminal ends of the respective ends 102 and 103. The fasteners 106 act as stops so that the engaging members 130 cannot be slid off of the ends 102 and 103 of the elongate member 101. The engaging members 130 are slid inward toward the connector assemblies 109 so that the flanges of the beam are positioned within the openings 142 and the engaging members 130 engage the flange of the beam. A lanyard or lifeline is operatively connected to the connector 110. The worker may perform tasks proximate the beam, and the slidable beam anchor 100 may slide along the length of the beam. When it is desired to disconnect the slidable beam anchor 100 from the beam, the worker may position a finger within the cavity 137 to press the activating portion 156 inward toward the connector assembly 109, which causes the locking portion 162 to move downward and become released from the notch 105. FIG. 22 shows the adjustment member 155 in an engaged position, in which the adjustment member 155 is entirely protected within the cavity 137, and FIG. 23 shows the adjustment member 155 in a released position. To move and release the locking portion 162 from the notch 105, it may be necessary to first push the engaging member 130 inward to allow the locking portion 162 to clear the perpendicular surface 105a on the side of the notch 105 closer to the respective end 102 or 103. In the released position, the engaging members 130 may be slid outward proximate the fastener 106 of the respective end 102 or 103.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A slidable beam anchor for anchoring a lanyard to a beam, comprising:
a) an elongate member having a length, a first end, a second end, and a plurality of notches extending along at least a portion of the length proximate at least one of the ends; and
b) at least one engaging member including a housing defining a cavity in which an adjustment member is pivotally connected to the housing, the adjustment member having a locking portion and an activating portion and being pivotable between an engaged position and a released position, the locking portion engaging one of the plurality of notches in the engaged position, the locking portion being disengaged from the plurality of notches in the released position, the adjustment member being protected within the cavity when in the engaged position thereby preventing accidental release of the adjustment member from the one of the plurality of notches.

2. The slidable beam anchor of claim 1, wherein the plurality of notches extend along at least a portion of a bottom surface of the elongate member, the housing extending downward from proximate the elongate member, the elongate member and the housing protecting the adjustment member in the engaged position.

3. The slidable beam anchor of claim 1, further comprising an interconnecting member interconnecting a connector and the elongate member, the connector proximate a top surface of the elongate member and being configured and arranged to be operatively connected to the lanyard, the plurality of notches extending along at least a portion of a bottom surface of the elongate member, the housing extending downward from proximate the elongate member, the elongate member and the housing protecting the adjustment member in the engaged position thereby preventing accidental release of the adjustment member from one of the plurality of notches by the lanyard during use of the beam anchor.

4. The slidable beam anchor of claim 1, wherein the activating portion is accessible through an opening in the housing, wherein when the activating portion is moved in an inward direction the locking portion moves from the engaged position downward away from the plurality of notches to the released position.

5. The slidable beam anchor of claim 1, wherein the engaging member is moved in a first inward direction to allow the locking portion to clear the one of the plurality of notches before the activating portion is moved in a second inward direction to move the locking portion from the engaged position downward away from the plurality of notches to the released position.

6. A slidable beam anchor for anchoring a lanyard to a beam, comprising:
a) an elongate member having a length, a first end, a second end, and a plurality of notches extending along at least a portion of the length proximate at least one of the ends;
b) a first engaging member slidably operatively connected to the first end, the first engaging member having a housing, a cavity, and an adjustment member, the cavity being positioned within the housing and the adjustment member being positioned within the cavity and pivotally operatively connected to the housing, the adjustment member having a locking portion and an activating portion, the adjustment member being pivotable between an engaged position and a released position, the engaged position being when the locking portion engages one of the plurality of notches, the released position being when the adjustment member is moved so that the locking portion is disengaged from the one of the plurality of notches, the adjustment member being protected within the cavity in the engaged position to prevent accidental release of the adjustment member from the one of the plurality of notches, the first engaging member being adjustable along the length of the elongate member; and
c) a second engaging member operatively connected to the second end, wherein the beam is engaged by the first engaging member and the second engaging member to slidably operatively connect the beam anchor thereto.

7. The slidable beam anchor of claim 6, wherein the housing extends downward proximate the elongate member and the cavity is positioned below the elongate member, the elongate member further assisting in preventing accidental release of the adjustment member from one of the plurality of notches.

8. The slidable beam anchor of claim 6, wherein the second engaging member is slidably operatively connected to the second end.

9. The slidable beam anchor of claim 6, wherein the plurality of notches extend along at least a portion of a bottom surface of the elongate member, the housing extending downward from proximate the elongate member, the elongate member and the housing protecting the adjustment member in the engaged position.

10. The slidable beam anchor of claim 6, further comprising an interconnecting member interconnecting a connector and the elongate member, the connector proximate a top surface of the elongate member and being configured and arranged to be operatively connected to the lanyard, the plurality of notches extending along at least a portion of a bottom surface of the elongate member, the housing extending downward from proximate the elongate member, the elongate member and the housing protecting the adjustment member in the engaged position thereby preventing accidental release of the adjustment member from one of the plurality of notches by the lanyard during use of the beam anchor.

11. The slidable beam anchor of claim 6, wherein the activating portion is accessible through an opening in the housing, wherein when the activating portion is moved in an inward direction the locking portion moves from the engaged position downward away from the plurality of notches to the released position.

12. The slidable beam anchor of claim 6, wherein the engaging member is moved in a first inward direction to allow the locking portion to clear the one of the plurality of notches before the activating portion is moved in a second inward direction to move the locking portion from the engaged position downward away from the plurality of notches to the released position.

13. A slidable beam anchor for anchoring a lanyard to a beam, comprising:
a) an elongate member including a length, a first end, a second end, and a plurality of notches extending along at least a portion of a bottom surface proximate at least one of the ends; and
b) at least one engaging member slidably operatively connected to one of the ends including a housing and an adjustment member, the housing including a top portion and a bottom portion, the top portion being configured and arranged to slidably engage the elongate member, the bottom portion including a first side and a second side extending downward from the top portion proximate a bottom surface of the elongate member, the first side and the second side defining a cavity therebetween, the adjustment member being pivotally operatively connected within the cavity between the first side and the second side, the adjustment member having a locking portion and an activating portion and being pivotable between an engaged position and a released position, the adjustment member being biased in the engaged position, the locking portion extending upward and configured and arranged to engage one of the plurality of notches within the housing when the adjustment member is in the engaged position, the activating portion extending downward and configured and arranged to be moved inward relative to the one of the ends thus causing the locking portion to move downward to disengage one of the plurality of notches to be in the released position, the locking portion and the activating portion being within the cavity of the housing in the engaged position thereby protecting the adjustment member within the housing in the engaged position, the housing and the elongate member protecting the adjustment member from accidental release from one of the plurality of notches by the lanyard during use of the slidable beam anchor.

14. The slidable beam anchor of claim of claim 13, further comprising an interconnecting member interconnecting a connector and the elongate member, the connector proximate a top surface of the elongate member and being configured and arranged to be operatively connected to the lanyard, the elongate member and the housing protecting the adjustment member in the engaged position thereby preventing accidental release of the adjustment member from one of the plurality of notches by the lanyard during use of the beam anchor.

15. The slidable beam anchor of claim 13, wherein the activating portion is accessible through an opening in the housing, wherein when the activating portion is moved in an inward direction the locking portion moves from the engaged position downward away from the plurality of notches to the released position.

16. The slidable beam anchor of claim 13, wherein the engaging member is moved in a first inward direction to allow the locking portion to clear the one of the plurality of notches before the activating portion is moved in a second inward direction to move the locking portion from the engaged position downward away from the plurality of notches to the released position.
